(19) United States
(12) Patent Application Publication
(10) Pub. No.: US 2012/0086710 A1
(43) Pub. Date: Apr. 12, 2012

(54) DISPLAY METHOD

(75) Inventors: Pei-Hsuan CHIANG, Miao-Li County (TW); Chien-Hung CHAN, Miao-Li County (TW); Ting-Sung CHIU, Miao-Li County (TW)

(73) Assignee: CHIMEI INNOLUX CORPORATION, Miao-Li County (TW)

(21) Appl. No.: 13/242,438

(22) Filed: Sep. 23, 2011

(30) Foreign Application Priority Data
Oct. 7, 2010 (TW) 99134244

(51) Int. Cl. G06T 15/00; G09G 3/36

(52) U.S. Cl. 345/419; 345/102

(57) ABSTRACT

A display method including the following steps is provided. In a first frame, a first image is displayed by a plurality of first regions of a display area of a display apparatus, and a dark image is displayed by a plurality of second regions of the display area of the display apparatus at the same time. The display area has a plurality of pixels arranged as an array. Each first region and each second region respectively includes at least one of the pixels, and the first regions and the second regions are uniformly distributed in the display area, respectively. In a second frame immediately after the first frame, the dark image is displayed by the first regions, and a second image is displayed by the second regions at the same time. The first image and the second image construct a three-dimensional (3D) image.

### CROSS-REFERENCE TO RELATED APPLICATION

This application claims the priority benefit of Taiwan application serial no. 99134244, filed Oct. 7, 2010. The entirety of the above-mentioned patent application is hereby incorporated by reference herein and made a part of this specification.

### BACKGROUND OF THE INVENTION

1. Field of the Invention

The present invention relates to a display method, in particular, to a display method for a three-dimensional (3D) image.

2. Description of Related Art

With the constant development of the technology, as for the development of the display technology, besides pursuing the object of light, thin, short, and small displays, the object of displaying a 3D image is also hoped to be achieved. Generally, the theory of displaying the 3D image is that, a left-eye image and a right-eye image which may form the 3D image are delivered to the left eye and the right eye respectively, so that a 3D image is constructed in a viewer's brain.

FIG. 1 is a schematic view of a conventional 3D display apparatus, which includes a display apparatus 20 and a pair of glasses 30. The display apparatus 20 receives and displays the left-eye image or the right-eye image delivered from the signal resource 10, and controls that the right-eye (left-eye) image is received only by the right eye (left eye) by turning on a right lens 32 (left lens 34) of the glasses 30 and turning off the left lens 34 (right lens 32). Referring to FIG. 1, since the signal resource 10 alternatively delivers the left-eye image and the right-eye image, in order to avoid the left eye of a viewer from seeing the right-eye image and to avoid the right eye of the viewer from seeing the left-eye image, when the display apparatus 20 displays the right-eye image, the right lens 32 of the glasses 30 is in the state of light-transmissive, so that the right-eye image displayed by the display apparatus 20 may achieve the right eye of the viewer. At this time, the left lens of the glasses 30 is in the state of light-opaque, so as to avoid the right-eye image displayed by the display apparatus 20 from achieving the left eye of the viewer. When the display apparatus 20 displays the left-eye image, the left lens 34 of the glasses 30 is in the state of light-transmissive, so that the left-eye image displayed by the display apparatus 20 may achieve the left eye of the viewer, and at this time, the right lens 32 of the glasses 30 is in the state of light-opaque, so as to avoid the left-eye images displayed by the display apparatus 20 from achieving the right eye of the viewer. In other words, as for the left eye or the right eye of the viewer, only single-eye images displayed by the display apparatus 20 can be seen (left-eye images or right-eye images). The display apparatus 20 is taken a liquid crystal display (LCD) as an example herein. The LCD has a plurality of pixels arranged as an array, and the various pixels appear different gray scales by controlling the reorientation of the liquid crystals molecules in the LCD, thus achieving different light-transmissive degrees and completing an image. Since the controlling the reorientation of the liquid crystals molecules needs some time to achieve the correct gray scale, in the process of switching to display the left-eye image and the right-eye image of the LCD, the LCD still fails to correctly display the left-eye image eventually in the case that the left lens 34 of the glasses 30 is in the state of light-transmissive. In other words, some pixels are still in the process of liquid crystal molecules reorientation, so that the left eye of the viewer will see the previous image (that is, the right-eye image herein). Likewise, the right eye of the viewer will also see the previous image of the left-eye image for the same reason, and this is called cross-talk. In this way, the effect of the 3D display is heavily reduced.

### SUMMARY OF THE INVENTION

Accordingly, the present invention is directed to two display methods, which solve the problem that the display quality is reduced due to cross-talk of the left-eye image and the right-eye image in the conventional method.

A display method of the present invention includes the following steps. In a first frame, a first image is displayed by a plurality of first regions of a display area of a display apparatus, and a dark image is displayed by a plurality of second regions of the display area of the display apparatus display at the same time. The display region has a plurality of pixels arranged as an array. Each first region includes at least one of the pixels, and the first regions are uniformly distributed in the display area. Each second region includes at least one of the pixels, and the second regions are uniformly distributed in the display area. In a second frame immediately after the first frame, the dark image is displayed by the first region of the display area of the display apparatus, and a second image is displayed by the second region of the display area of the display apparatus at the same time. The first image and the second image construct a 3D image.

Another display method of the present invention is used for displaying a 3D image, which includes the following steps. The 3D image is constructed by a first image and a second image, and an image capturing time difference between the first image and the second image is less than 1/60 second. In a first frame, the first image is displayed by a plurality of first regions of a display area of the display apparatus, and a dark image is displayed by a plurality of second regions of the display area of the display apparatus at the same time. The display area has a plurality of pixels arranged as an array. Each first region includes at least one of the pixels, and the first regions are uniformly distributed in the display area. Each second region includes at least one of the pixels, and the second regions are uniformly distributed in the display area. In a second frame immediately after the first frame, the dark image is displayed by the first region of the display area of the display apparatus, and the second image is displayed by the second region of the display area of the display apparatus.

In an embodiment of the present invention, the first regions have odd-row pixels, and the second regions have even-row pixels.

In an embodiment of the present invention, the first regions have odd-column pixels, and the second regions have even-column pixels.

In an embodiment of the present invention, the first regions and the second regions are interlaced into a checkerboard pattern.

In an embodiment of the present invention, a total area of the first regions is equal to a total area of the second regions.

In an embodiment of the present invention, the image capturing time difference of the first image and the second image is less than 1/60 second.

In an embodiment of the present invention, image capturing angles of the first image and the second image are different.

In an embodiment of the present invention, the dark image is a black image.

In an embodiment of the present invention, the display apparatus includes a liquid crystal panel and a backlight module. The liquid crystal panel has the display area, and the backlight module turns on in the whole time during the first frame and the second frame.

In an embodiment of the present invention, the display apparatus includes a liquid crystal panel and a backlight module. The liquid crystal panel has the display area, and the backlight module turns on in part time during the first frame and the second frame.

In view of the above, in the display method of the present invention, the first regions that display the first image in the first frame are used to display the black image in the second frame, so that the cross-talk phenomenon between the first image and the second image is alleviated, thus improving the display quality.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional 3D display apparatus.

FIG. 2 is a timing chart of states of the components when a display apparatus executes a display method according to an embodiment of the present invention.

FIG. 3 is a schematic view of a display area of the display apparatus.

FIG. 4 shows a display state of the display area of the display apparatus during various frames.

FIG. 5 is a schematic view of a display apparatus executing the display method according to the above embodiment of the present invention; and

FIGS. 6 to 9 show the display state of the display area of the display apparatus during various frames in the display methods of other embodiments.

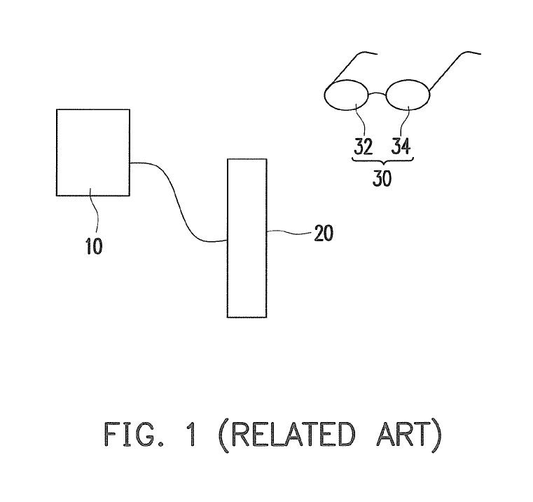

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

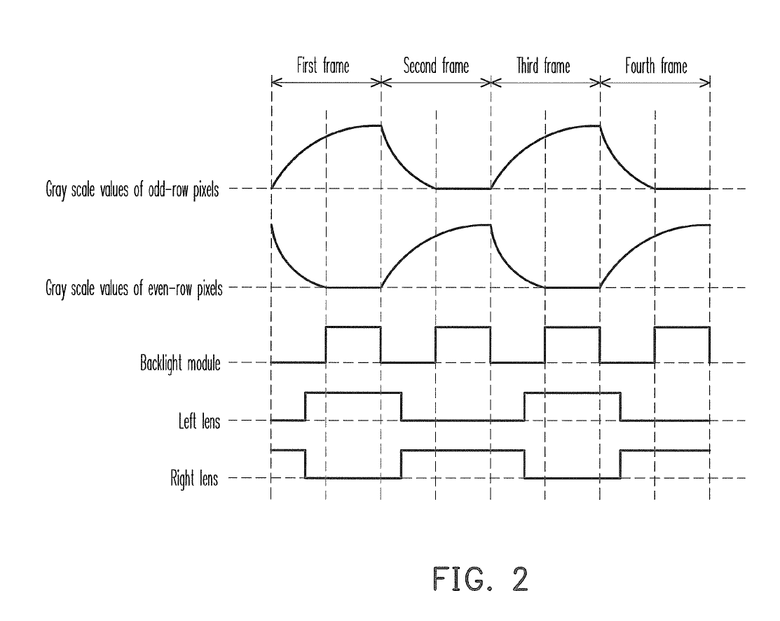

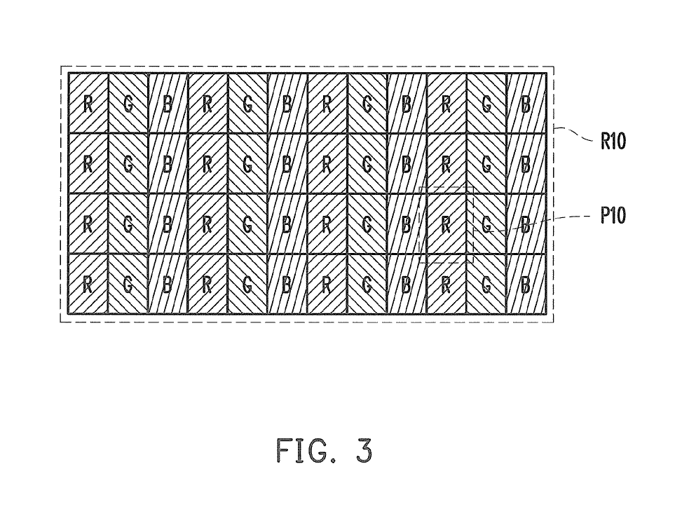

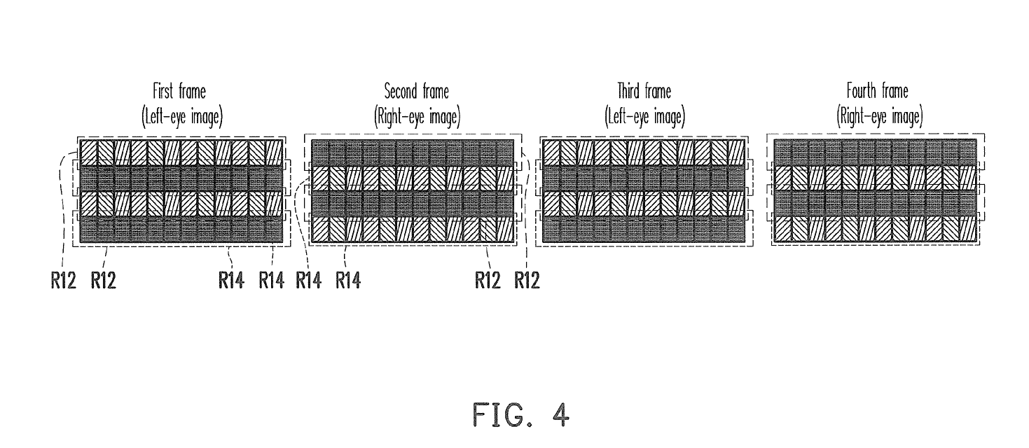

FIG. 2 is a timing chart of states of various components when the display apparatus executes a display method according to an embodiment of the present invention; FIG. 3 is a schematic view of a display area of the display apparatus; and FIG. 4 shows a display state of the display area of the display apparatus during various frames. Referring to FIG. 3, a display method in this embodiment may be applied in a display area R10 of a display apparatus. For example, the display area R10 has a plurality of pixels P10 arranged as an array. Each pixel P10 is used to display one of the three primary colors, namely, red (R), green (G) or blue (B), but each pixel P10 may also independently display various colors. For example, the former one uses a color filter, and the latter one uses a color sequential method, which depends on the design of the display apparatus.

The display method of this embodiment includes the following steps. Referring to FIG. 2 and FIG. 4, in a first frame, a first image is displayed by a plurality of first regions R12 of the display area R10 of the display apparatus, and a dark image is displayed by a plurality of second regions R14 of the display area R10 of the display apparatus at the same time. Specifically, in the first frame, the content displayed by each first region R12 takes from the content of the first image, and all the second regions R14 display the same dark gray scale. In a second frame immediately after the first frame, the dark image is displayed by the first regions R12 of the display area R10 of the display apparatus, and a second image is displayed by the second regions R14 of the display area R10 of the display apparatus. Specifically, in the second frame, all the first regions R12 display the same dark gray scale, and the content displayed by all the second regions R14 takes from the content of the second image.

Referring to FIG. 3 and FIG. 4, the first regions R12 are uniformly distributed in the display area R10, and the second regions R14 are also uniformly distributed in the display area R10. That is to say, the first regions R12 and the second regions R14 are interlaced, and the sum of the first regions R12 and the second regions R14 is the complete display area R10. A total area of the first regions R12 is, for example, equal to a total area of the second regions R14. In this embodiment, the first regions R12 have odd-row pixels P10 and may display odd-row content corresponding to the first image, and the second regions R14 have even-row pixels P10 and may display the dark image. The first image and the second image are used to construct a 3D image. For example, when a photographic apparatus shoots the first image and the second image which need to be displayed, the two images may be captured at the same time, or an image capturing time difference between the two images is less than 1/60 second. In another aspect, in order to enable the viewer to obtain the distance sense of an object from the sum of the first image and the second image, image capturing angles of the first image and the second image has a slight difference, so as to imitate the view point difference when eyes of a human see the same object.

It can be known from the above that, the first regions R12 are used to display the first image in the first frame, and are used to display the dark image in the second frame. The second regions R14 are used to display the dark image in the first frame, and are used to display the second image in the second frame. It is supposed that the first image is a left-eye image to be delivered to the left eye of the viewer, and the second image is a right-eye image to be delivered to the right eye of the viewer in the following. As for the first regions R12, the left eye of the viewer may see the first image in the first frame, and the right eye of the viewer only sees the dark image in the second frame. As for the second regions R14, the right eye of the viewer only sees the dark image in the first frame, and the left eye of the viewer may see the second image in the second frame. As for the single eye, when the dark image is generated, the vision of the eye has the feature of motion tracking, and thus the brain of the viewer has time to compensate the non-continuous place between the images, thus reducing the cross-talk phenomenon of the viewer. Even if the display apparatus has low speed of image switching, the cross-talk phenomenon of switching the first image to the dark image is slight, and the cross-talk phenomenon of switching the dark image to the second image is also slight. Therefore, the display method of the present invention can not only alleviate the cross-talk phenomenon, but also improve the display quality.

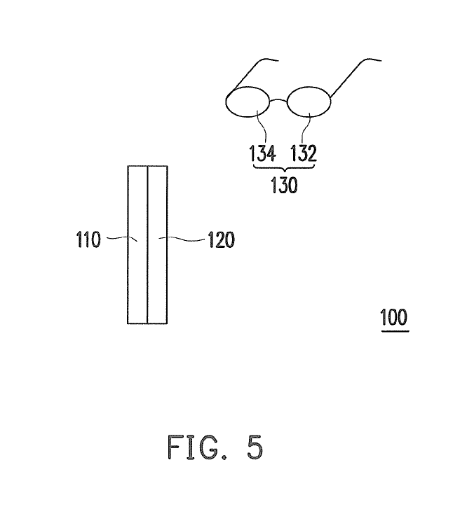

FIG. 5 is a schematic view of the display apparatus executing the display method of the above embodiment. Referring to FIG. 2 and FIG. 5, the display apparatus 100 in this embodiment includes a liquid crystal panel 120, a backlight module 110, and a pair of glasses 130, in which the liquid crystal panel 120 has a display area R10 which is as shown in FIG. 3 and may display an image. The glasses 130 include a left lens 132 and a right lens 134. Referring to FIG. 2 and FIG. 4, in the first frame, the pixels P10 of the first regions R12 are driven and achieve a gray scale required to display in the rear of the first frame, and the pixels P10 of the second region R14 are driven and achieve a low gray scale in the rear of the first frame. In this embodiment, the dark image displayed by the second regions R14 in the first frame is a black image, that is, the second regions R14 is black eventually in an ideal state. However, in other embodiments, the dark image to be displayed by the second regions R14 in the first frame may also in a low gray scale, instead of a black image, as long as the images displayed by all the second regions R14 are all identical or similar low gray scale images. The dark image to be displayed by the first regions R12 in the second frame may also be a black image or a low gray scale image.

In the rear of the first frame and the second frame, after the first regions R12 and the second regions R14 achieve a stable displaying state, the backlight module 110 turns on. In this way, the possibility of distortion of the image seen by the viewer may be reduced. The forepart of each frame is an update period used for updating the image, and the rear of each frame is a display period used for displaying the correct images for the viewer. Specifically, the update period is a period in which the liquid crystal molecules are driven by a voltage to a gray scale to be displayed after an image signal is input, and the display period is a period of displaying the correct gray scale image after the driving of the liquid crystal molecules are completed. Since the left lens 132 and the right lens 134 of the glasses 130 need to be in the display period independently to receive a correct image through light transmission, the backlight module 110 can be increased the brightness to keep the brightness of the whole image when the backlight module 110 is not turned on in full time. Definitely, the backlight module 110 may also be turned on in the whole time, and many conventional arts may reduce the possibility of distortion of the image seen by the viewer. In addition, during the period from the time when the backlight module 110 is turned on to the time when the backlight module 110 is turned off, the left lens 132 of the glasses 130 is enabled to be in the state of light-transmissive, and the right lens 134 of the glasses 130 is enabled to be in the state of light-proof, so that the left-eye image displayed by the first regions R12 and the dark image displayed by the second regions R14 may achieve the left eye of the viewer, and the left-eye image is avoided from achieving the right eye of the viewer. In addition, the time point that the left lens 132 is converted from the light-proof state to the light-transmissive state is earlier than the time point that the backlight module 110 is turned on in the first frame, and the time point that the left lens 132 is converted from the light-proof state to the light-transmissive state is later than the time point that the backlight module 110 is turned off, so that the light-transmissive time of the left lens 132 is longer than the opening time of the backlight module 110. In this way, the time of receiving the left-eye image for the viewer is increased, and the image brightness felt by the viewer is improved. The operation manner of the right lens 134 is similar to the left lens 132, and will not be repeated herein.

It should be noted that, the display method of the present invention may be executed not only on a liquid crystal display apparatus, but also on a plasma display apparatus, an organic electroluminescence display apparatus or other display apparatuses.

In addition, in this embodiment, in a third frame immediately after the second frame and similar to the first frame, a third image is displayed by the first regions R12, and the dark image is displayed by the second regions R14 at the same time. In a fourth frame immediately after the third frame and similar to the second frame, the dark image is displayed by the first regions R12, and a fourth image is displayed by the second regions R14 at the same time. It is supposed that the first image and the third image are left-eye images to be delivered to the left eye of the viewer, and the second image and the fourth image are right-eye images to be delivered to the right eye of the viewer. In other words, the first regions R12 either display the left-eye image or display the dark image, and the second regions R14 either display the right-eye image or display the dark image.

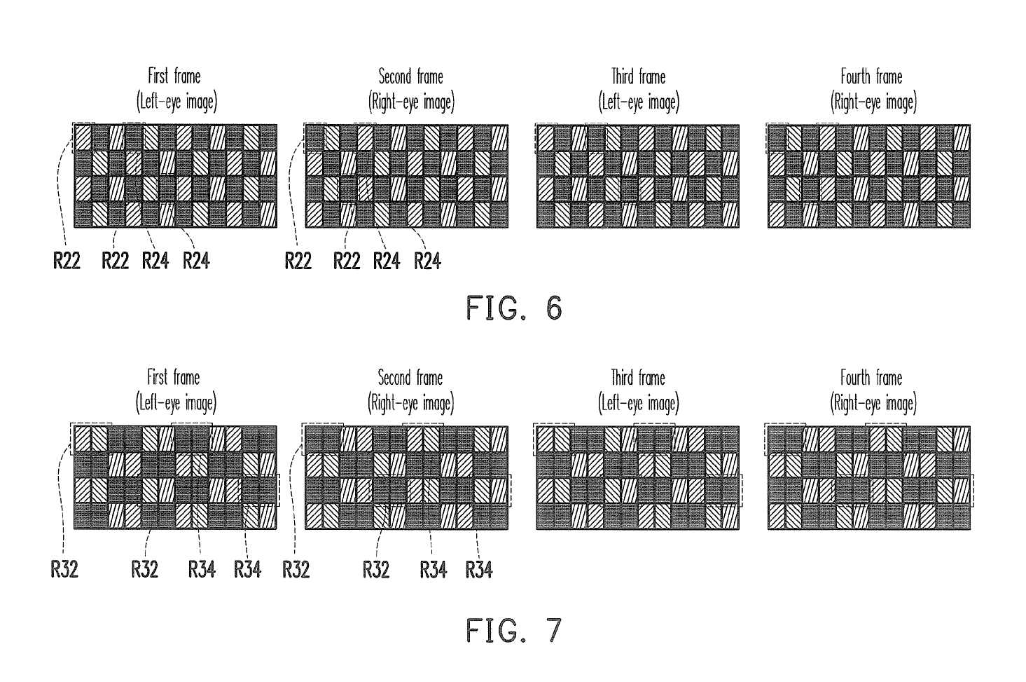

In the embodiment of FIG. 6, the first regions R22 and the second regions R24 are interlaced into a checkerboard pattern. Each first region R22 only has one pixel, and each second region R24 also only has one pixel. The first regions R22 display in sequence the first image, the dark image, the third image, and the dark image in the four frames, and the second regions R24 display in sequence the dark image, the second image, the dark image, and the fourth image in the four frames. The first image and the third image are left-eye images, and the second image and the fourth image are right-eye images. The first image and the second image are used to construct a 3D image, and the third image and the fourth image are used to construct another 3D image. It can be known that, the display method of the present invention does not limit the distribution manner of the first regions and the second regions.

In the embodiment of FIG. 7, the first regions R32 and the second regions R34 are also interlaced into a checkerboard pattern. However, each first region R32 has two pixels, and each second region R34 also has two pixels.

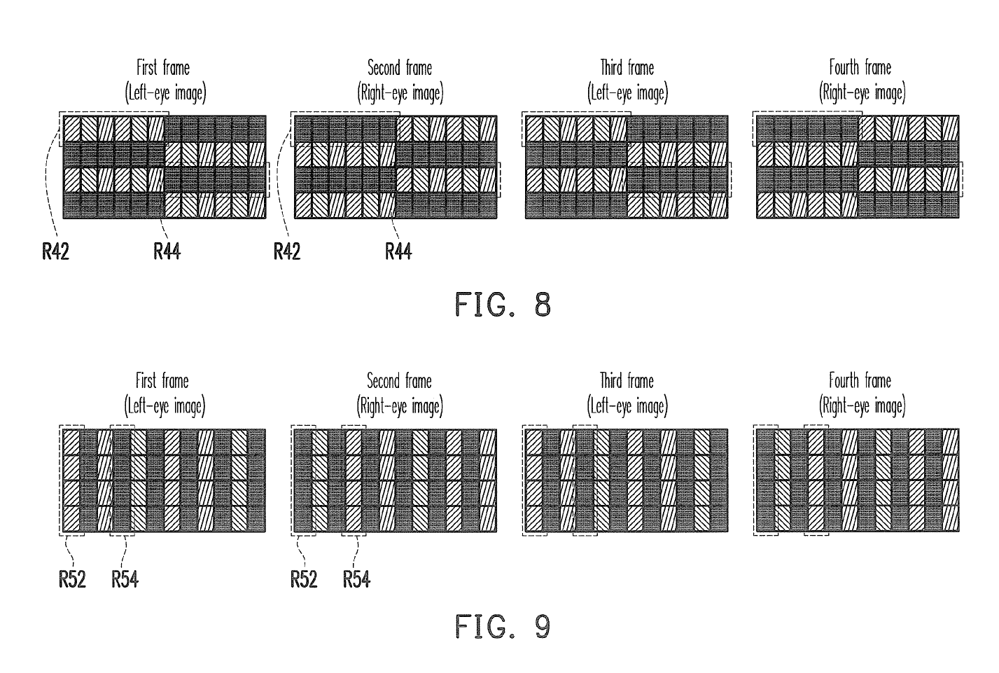

In the embodiment of FIG. 8, the first regions R42 and the second regions R44 are also interlaced into a checkerboard pattern. However, each first region R42 has six pixels (two red pixels, two green pixels, and two blue pixels), and each second region R44 also has six pixels (two red pixels, two green pixels, and two blue pixels).

In the embodiment of FIG. 9, the first regions R52 have odd-column pixels, and the second regions R52 have even-column pixels.

In addition, in order to implement the display method of the above embodiments, a timing controller of the display apparatus should insert data of the first image into a plurality of pieces of data of the low gray scale after receiving the data of the first image, and output the data in sequence to the pixels of the display apparatus after reordering, so as to accord with the requirement of the display methods of various embodiments. Definitely, the inserting data of the low gray scale and the reordering may be executed by a computer or a scaler of other signal resources before the data is input in the display apparatus.

Above all, in the display method of the present invention, the same regions of the display apparatus display the image to be watched by the viewer in only one frame of two adjacent frames, and display the dark image in the other frame, and therefore, the cross-talk phenomenon between images in adjacent frames may be alleviated, and the display quality of the 3D image is also improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display method, comprising:
displaying a first image by a plurality of first regions of a display area of a display apparatus, and displaying a dark image by a plurality of second regions of the display area of the display apparatus at the same time in a first frame, wherein the display area comprises a plurality of pixels arranged as an array, each first region comprises at least one of the pixels, the first regions are uniformly distributed in the display area, each second region comprises at least one of the pixels, and the second regions are uniformly distributed in the display area; and
displaying the dark image by the first regions of the display area of the display apparatus, and displaying a second image by the second regions of the display area of the display apparatus at the same time in a second frame immediately after the first frame, wherein the first image and the second image construct a 3D image.

2. The display method according to claim 1, wherein the first regions comprise the odd-row pixels, and the second regions comprise the even-row pixels.

3. The display method according to claim 1, wherein the first regions comprise the odd-column pixels, and the second regions comprise the even-column pixels.

4. The display method according to claim 1, wherein the first regions and the second regions are interlaced into a checkerboard pattern.

5. The display method according to claim 1, wherein a total area of the first regions is equal to a total area of the second regions.

6. The display method according to claim 1, wherein an image capturing time difference between the first image and the second image is less than 1/60 second.

7. The display method according to claim 1, wherein image capturing angles of the first image and the second image are different.

8. The display method according to claim 1, wherein the dark image is a black image.

9. The display method according to claim 1, wherein the display apparatus comprises a liquid crystal panel and a backlight module, the liquid crystal panel comprises the display area, and the backlight module turns on in the whole time in the first frame and the second frame.

10. The display method according to claim 1, wherein the display apparatus comprises a liquid crystal panel and a backlight module, the liquid crystal panel comprises the display area, and the backlight module turns on in part time in the first frame and the second frame.

11. A display method, for displaying a 3D image, wherein the 3D image is constructed by a first image and a second image, and a image capturing time difference between the first image and the second image is less than 1/60 second, the method comprising:
displaying the first image by a plurality of first regions of a display area of a display apparatus, and displaying a dark image by a plurality of second regions of the display area of the display apparatus at the same time in a first frame, wherein the display area comprises a plurality of pixels arranged as an array, each first region comprises at least one of the pixels, the first regions are uniformly distributed in the display area, each second region comprises at least one of the pixels, and the second regions are uniformly distributed in the display area; and
displaying the dark image by the first regions of the display area of the display apparatus, and displaying the second image by the second regions of the display area of the display apparatus at the same time in a second frame immediately after the first frame.

12. The display method according to claim 11, wherein the first regions comprise the odd-row pixels, and the second regions comprise the even-row pixels.

13. The display method according to claim 11, wherein the first regions comprise the odd-column pixels, and the second regions comprise the even-column pixels.

14. The display method according to claim 11, wherein the first regions and the second regions are interlaced into a checkerboard pattern.

15. The display method according to claim 11, wherein a total area of the first regions is equal to a total area of the second regions.

16. The display method according to claim 11, wherein image capturing angles of the first image and the second image are different.

17. The display method according to claim 11, wherein the dark image is a black image.

18. The display method according to claim 11, wherein the display apparatus comprises a liquid crystal panel and a backlight module, the liquid crystal panel comprises the display area, and the backlight module turns on in the whole time in the first frame and the second frame.

19. The display method according to claim 11, wherein the display apparatus comprises a liquid crystal panel and a backlight module, the liquid crystal panel comprises the display area, and the backlight module turns on in part time in the first frame and the second frame.
